(19) United States
(12) Patent Application Publication
(10) Pub. No.: US 2008/0086493 A1
(43) Pub. Date: Apr. 10, 2008

(54) APPARATUS AND METHOD FOR ORGANIZATION, SEGMENTATION, CHARACTERIZATION, AND DISCRIMINATION OF COMPLEX DATA SETS FROM MULTI-HETEROGENEOUS SOURCES

(75) Inventor: QIUMING ZHU, Omaha, NE (US)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: Board of Regents of University of Nebraska, Lincoln, NE (US)

(21) Appl. No.: 11/869,051

(22) Filed: Oct. 9, 2007

Related U.S. Application Data
(60) Provisional application No. 60/828,729, filed on Oct. 9, 2006.

(51) Int. Cl. G06F 7/00

(52) U.S. Cl. 707/101; 707/E17.046

(57) ABSTRACT

A system and method is disclosed for modeling and discriminating complex data sets of large information systems. The system and method aim at detecting and configuring data sets of different categories in nature into a set of structures that distinguish the categorical features of the data sets. The method and system captures the expressional essentials of the information characteristics and accounts for uncertainties of the information piece with explicit quantification useful to infer the discriminative nature of the data sets.

### CROSS-REFERENCE TO RELATED APPLICATIONS

This application claims the benefit of U.S. Provisional Application No. 60/828,729 filed on Oct. 9, 2006, which is incorporated herein by reference.

### STATEMENT REGARDING FEDERALLY SPONSORED RESEARCH OR DEVELOPMENT

Not applicable.

### TECHNICAL FIELD

The present invention relates to a data clustering technique, and more particularly, to a data clustering technique using hyper-ellipsoidal clusters

### BACKGROUND OF THE INVENTION

Considerable resources have been applied to accurately model and characterize (measure) large amount of information, such as from databases and Web open resources. This information typically consists of enormous amount of highly intertwining—mixed, uncertain, and ambiguous—data sets of different categorical natures in a multiple dimensional space of complex information systems.

One of the problems often encountered in systems of data management and analysis is to derive an intrinsic model description on a set or sets of data collections in terms of their inherent properties, such as their membership categories or statistical distribution characteristics. For example, in a data fusion and knowledge discovery process to support decision making, it is necessary to extract the information from a large set of data points and model the data in terms of uniformity and regularities. This is often done by first obtaining the categorical classifications of the data sets that are grouped in terms of one or more designated key fields, regarded as labels, of the data points, and then mapping them to a set of objective functions. An example of this application is the detection of spam email texts where the computer system needs to have a data model developed from a large set of text data collected from a large group of resources, and then classifying them according to their likelihood or certainty to the target text to be detected.

The problem is also manifested in the following two application cases. In the data fusion and information integration processes, a constant demand exists to manage and operate on a very large amount of data. How to effectively manipulate the data has been an issue from the starting age of the information systems and technology. For example, a critical issue is how to guarantee the collected and stored data are consistent and valid in terms of the essential characteristics (e.g., categories, meanings) of the data sets. Second, in the Internet security and information assurance domain, it is critical to determine whether the data received is normal (e.g., not spam email), and thus safe. It is difficult because the abnormal case is often very similar to the normal case. Their distributions are closely mixed with each other. Coding and encryption techniques do not work in most of these situations. Thus, an analysis and detection of the irregularity and singularity via the analysis of the individual data received is undertaken.

In data analysis, clustering is the most fundamental approach. The clustering process divides data sets into a number of segments (blocks) considering the singularity and other features of the data. The following issues are of concern in clustering:

a) The linear model is too simple to properly describe (represent) the data sets in modem, complex information systems.

b) Non-linear models therefore are necessary to model data in modern information systems, such as for example, data organizations on the Web, knowledge discovery and interpretation of the data sets, information security protection and data accuracy assurance, reliable decision making under uncertainties.

c) Higher order non-linear data models are typically too complicated for computation and manipulation. And it suffers from unnecessary computational cost. Thus, there is a trade off between the computational cost and accuracy gained.

### SUMMARY OF THE INVENTION

The present invention generally relates to a system and method for modeling and discriminating complex data sets of large information systems. The method detects and configures data sets of different categories in nature into a set of structures that distinguish the categorical features of the data sets. The method and system determines the expressional essentials of the information characteristics and accounts for uncertainties of the information piece with explicit quantification useful to infer the discriminative nature of the data sets.

The method is directed at detecting and configuring data sets of different categories in numerical expressions into multiple hyper-ellipsoidal clusters with a minimum number of the hyper-ellipsoids covering the maximum amount of data points of the same category. This clustering step attempts to encompass the expressional essentials of the information characteristics and account for uncertainties of the information piece with explicit quantification. The method uses a hierarchical set of moment-derived multi-hyper-ellipsoids to recursively partition the data sets and thereby infer the discriminative nature of the data sets. The system and method are useful for data fusion and knowledge extraction from large amounts of heterogeneous data collections, and to support reliable decision-making in complex information rich and knowledge-intensive environments.

### BRIEF DESCRIPTION OF THE SEVERAL VIEWS OF THE DRAWINGS

The present invention is described in detail below with reference to the attached drawing figures, wherein:

FIG. 1 is a block diagram of a data space R(X) and its linear partition R(ωᵢ)s;

FIG. 2 is a diagram showing the data sets in concave and discontinuous distributions;

FIG. 3 is a diagram showing a Mini-Max hyper-ellipsoidal subclass model based on the data sets of FIG. 2;

FIG. 4 are diagrams showing multi-ellipsoidal clusters of data mixtures;

FIG. 5 are diagrams showing multi-ellipsoidal clusters of intertwined data sets;

FIG. 6 are also diagrams showing multi-ellipsoidal clusters of intertwined data sets;

FIG. 7 are diagrams showing the method of the present invention operating on randomly generated data sets;

FIG. 8 are diagrams showing ring shaped distributions of the data sets;

FIG. 9 shows diagrams of an experiment on the iris data set; and

FIG. 10 shows diagrams of the results of the present method on the iris data set;

FIG. 11 shows a table a collection of records that keeps track of personal financial transactions;

FIG. 12 shows illustrations of data distributions (from different dimensional views); and

FIG. 13 shows a binary tree diagram demonstrating the purification of the data sets by applying the hyper-ellipsoidal clustering and subdivisions method of the present invention.

### DETAILED DESCRIPTION OF THE INVENTION

It is known that structures of data collections in information management may be viewed as a system of structures with mass distributions at different locations in the information space. Each group of these mass distributions is governed by its moment factors (centers and deviations). The data management system of the present invention detects and uses these moment factors for extracting the regularities and distinguishing the irregularities in data sets.

The system and method of the present invention further minimize the cross-entropy of the distribution functions that bear considerable complexity and non-linearity. Applying the Principle of Minimum Cross-Entropy, the data sets are partitioned into a minimum number of hyper-ellipsoidal subspaces according to their high intra-class and low inter-class similarities. This leads to a derivation of a set of compact data distribution functions for a collective description of data sets at different levels of accuracy. These functions, in a combinatory description of the statistical features of the data sets, serve as an approximation to the underlying nature of their hierarchical spatial distributions.

This process comports with the results obtained from a study of quadratic (conic) modeling of the non-linearity of the data systems in large information system management. In the quadratic non-linearity principle, data sets are configured and described by a number of subspaces each associated with a distribution function formulated according to the regularization principle. It is known that among non-linear models, the quadratic (conics) is the simplest and most often used. When properly organized, it may approximate the complex data systems with a certain satisfactory level of accuracy. The Conic model has some unique properties that are not only advantages to the capability of a linear model, but also precedes some higher-order non-linear models. For example, the additive property of conics allows for a combination of multiple conic functions to approximate a data distribution in a very high order of complexity. Thus, the data model may be constructed that fits most non-linear data systems with satisfactory accuracy.

Ellipses and ellipsoids are convex functions of the quadratic function family. And, convexity is an important criteria for any data models. This property makes the ellipsoidal model unique and useful to model data systems. Thus, the system of the present invention is operable on a category-mixed data set and continues to operate on the clusters of the category-mixed data sets. The process starts with the individual data points of the same category (within the space of category-mixed data set), and gradually extends to data points of other categories of the category-mixed data sets. Data is processed from sub-sets to the whole set non-recursively. The process is applicable to small sized, moderate sized and very large sized data sets, and applicable to moderately mixed data sets and to heavily mixed data sets of different categories. The process is very effective for separation of data in different categories and is useful for finding the data discriminations, which is particularly useful in decision support. Further, the process can be conducted in accretive manner, such that the data points are added one-by-one gradually as the process operates.

The main feature of the system and method of the present invention is that data points of each class are clustered into a number of hyper-ellipsoids, rather than one linear or flat region in a data space. In a general data space, a data class may have a nonlinear and discontinuous distribution, depending on the complexity of the data sets. A data class therefore may not be modeled by a single continual function in a data space, but approximated by two or more functions each in a sub-space. The similarities and dissimilarities of data points in these sub-spaces are best described in a number of individual distribution functions, each corresponding to a cluster of the data points.

While a class distribution is traditionally described by a single Gaussian function, it is possible, and often required, to describe a class distribution in multiple Gaussian distributions. A combination of these distributions may then form the entire distribution of the data points in real world. In the case of Gaussian-function modeling, these subspaces are hyper-ellipsoids. That is, the distributions of the data classes are modeled by multiple hyper-ellipsoidal clusters. These clusters accrete dynamically in terms of an inclusiveness and exclusiveness evaluation with respect to certain criteria functions.

Another important feature of the system and method of the present invention is that classifiers for a specific data class may be formed individually on the hyper-ellipsoid clustering of the samples. This allows for incremental and dynamic construction of the classifiers.

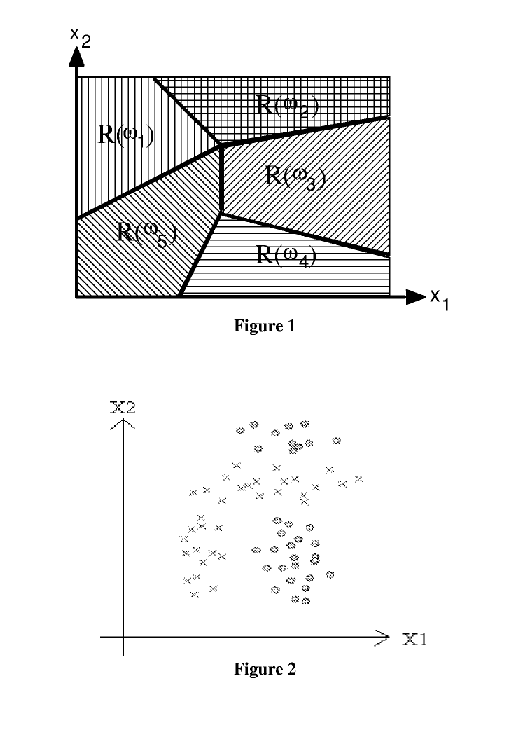

Many known data analyzing systems deal with the relations between a set of known classes (categories), denoted as Ω={ω₁, ω₂, . . . , ω_{c}}, and a set of known data points (vectors), denoted as x=[x₁, x₂, . . . , xₙ]. The total possible occurrences of the data points xs form an n-dimensional space R(x). Collections of the xs partition the R(x) into regions R(ωᵢ), i=1, 2, . . . , c, where
R(ωᵢ)⊂R(x), ∪ᵢR(ωᵢ)=R(x), and R(ωᵢ)∩R(ωⱼ)=Ø; ∀ⱼ≠i.
The R(ωᵢ)s represent clusters of xs based on the characteristics of the ωᵢs. The surfaces, called decision boundaries, that separate these R(ωᵢ) regions are described by discriminate functions, denoted as πᵢ(x), i=1, 2, . . . , c. This formulation can also be described as:
R(ωᵢ)={x|∀(j≠i)[πᵢ(x)>πⱼ(x)]}, where xεR(x) & ωᵢεΩ.
Very often, the R(ωᵢ)s are convex and continual, and render the πᵢ(x)s to be linear or piece-wise linear functions, such as the example shown in FIG. 1.

However, cases may exist where the R(ωᵢ) regions do not possess the above linearity feature because of the irregular and complex distributions of the feature vector xs. FIG. 2 shows an example in which the data points of class 1 have a concave distribution and that of class 2 have a discontinuous distribution. These kinds of distributions are not unusual in many real world applications, such as the recognition of text characters printed in different fonts and the recognition of words in speeches of different peoples.

For the data discrimination problems shown in FIG. 2, the boundaries that partition the R(ωᵢ)s can no longer be accurately described by linear or piece-wise linear functions. That is, to form precise R(ωᵢ) regions, the πᵢ(x)s are required to be high-order nonlinear functions. These functions, if not totally impossible, are often very computationally expensive to obtain. Previous methods of applying linear or piece-wise linear approximations lose the statistical precision that is embedded in the pattern class distributions.

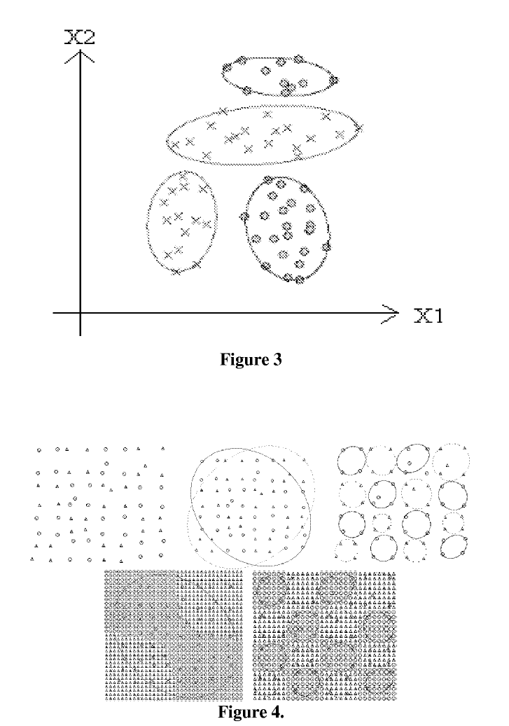

The system of the present invention is based on the nonlinear modeling of the statistical distributions of the data collections, which likewise reduces the complexity of the distribution. The system of the present invention models a complexly distributed data set as a number of subsets, each with a relatively simple distribution. In this modeling, subset regions are constructed as subspaces within a multi-dimensional data space. Data collections in these subspaces have high intra-subclass and low inter-subclass similarities. The overall distribution of a data class is a combining set of the distributions of the subclasses (not necessary to be additive). In this sense, subclasses of one data class are the component clusters of the data sets, as the example shows in FIG. 3.

Statistically, an optimal classifier is one that minimizes the probability of overall decision error on the samples in the data vector space. For a given observation vector x of unknown class membership, if class distributions p(x|ωᵢ) and prior probabilities P(ωᵢ) for the class ωᵢ, (i=1, 2, . . . , w) are provided, then a posterior probability p(ωᵢ|x) can be computed by Bayes rule and an optimal classifier can be formed. It is known that the class distributions {p(x|ωᵢ); i=1, 2, . . . , w} dominate the computation of the classifier.

Let \hat{P}(x|ωᵢ)=P(x|Sᵢ) be the class-conditional distribution of x defined on the given data set Sᵢ of class ωᵢ. The \hat{P}(x|ωᵢ) under the subclass modeling can be expressed as a combination of the sub-distribution P(x|εᵢₖ)s such that:

$$\hat{P} ( x \vert {ω}_{i} ) = \{ \begin{matrix}P ( x \vert {ɛ}_{i 1} ) ; & ∀ x ∈ R ( {ω}_{i 1} ) \\ P ( x \vert {ɛ}_{i 2} ) ; & ∀ x ∈ R ( {ω}_{i 2} ) \\ … & … \\ P ( x \vert {ɛ}_{i {d}_{i}} ) ; & ∀ x ∈ R ( {ω}_{{id}_{i}} )\end{matrix}$$

From the fact that R(ωᵢₖ)∩R(ωᵢₗ)=Ø, ∀1≠k, the \hat{P}(x|ωᵢ) can actually be computed by:
\hat{P}(x|ωᵢ)=MAX{P(x|εᵢₖ); k=1, 2, . . . dᵢ}.

From Condition 4 of the subclass cluster definition and the above expression of \hat{P}(x|ωᵢ), we have the following fact:
∀(xεSᵢ)∀(j≠i)[\hat{P}(x|ωᵢ)≧\hat{P}(x|ωⱼ)].

The above leads to the conclusion that a classifier built on the subclass model is a Bayes classifier in terms of the distribution functions P(x|εᵢₖ) defined on the subclass clusters. This can be verified by the following observations. It is know that a Bayes classifier classifies a feature vector xεR(x) to class ωᵢ based on an evaluation ∀(j≠i) P(x|ωᵢ)≧P(x|ωⱼ) (assuming P(ω₁)=P(ω₂)= . . . =P(ω_{c})). That is, any data vector xεR(ωᵢ) satisfies the condition P(x|ωᵢ)≧P(x|ωⱼ). Combining the equation of paragraph 0044 with the facts expressed in equations of paragraph 0034, we have ∀xεR(ωᵢ)[\hat{P}(x|ωᵢ)≧\hat{P}(x|ωⱼ)]. Notice that \hat{P}(x|ωᵢ)=MAX{P(x|εᵢₖ)}, that is, for any data vector xεR(x), [\hat{P}(x|ωᵢ)≧\hat{P}(x|ωⱼ)] means that ∃k∀j≠i[P(x|εᵢₖ)≧P(x|εⱼₗ)]. Therefore a classifier built on the subclasses is a Bayes classifier with respect to the distribution functions P(x|εᵢₖ)s.

The above discussion also leads to the following observation: Under the condition that the a priori probabilities are all equal (i.e., ∀(ωᵢ, ωⱼεΩ)P(ωᵢ)=P(ωⱼ)), the decision rule for the classifier built on the subclass model can be expressed as
∀x∀(j≠i)∃k[P(x|εᵢₖ)≧P(x|εⱼₗ)] [symbol] (xεωᵢ); where xεR(x), and ωᵢεΩ.

This fact is of special interest in terms of the use of this method for enhancing the reliability of decision making in complex information systems.

The technical bases for hyper-ellipsoidal clustering is established as follows. Let S be a set of labeled data points (records), xₖs, i.e., S={xₖ; k=1, 2, . . . , N}, in which each data point xₖ is associated with a specific class Sⱼ, i.e.,

$$S = {⋃}_{i = 1}^{c} {S}_{i} , {S}_{i} ⋂ {S}_{j} = O / ; ∀ i \neq j ,$$

where Sᵢ is a set of data points that are labeled by ωᵢ, ωᵢεΩ={ωᵢ; i=1, 2 . . . , c}. That is, for each xₖεS, there exists an i, (i=1, 2, . . . , c), such that [(xₖεSᵢ) [symbol] (xₖεωᵢ)].
Definition:
Let Sᵢ be a set of data points of type (category) ωᵢ, Sᵢ⊂S and ωᵢεΩ. Let εᵢₖ be the kth subset of Sᵢ. That is, εᵢₖ⊂Sᵢ, where k=1, 2, . . . dᵢ, and dᵢ is the number of subsets in Sᵢ.
Let P(x|εᵢₖ) be a distribution function of the data point x included in εᵢₖ. The subclass clusters of Sᵢ are defined as the set {εᵢₖ} that satisfies the following Conditions:

$$\begin{matrix}1 ) & {⋃}_{k = 1}^{{d}_{i}} {ɛ}_{ik} = {S}_{i} , \\ 2 ) & ∀ ( 1 \neq k ) [ {ɛ}_{ik} ⋂ {ɛ}_{il} = O / ] , \\ 3 ) & ∀ ( 1 \neq k ) [ ( x ∈ {ɛ}_{ik} ) ⇒ ( P ( x \vert {ɛ}_{ik} ) > P ( x \vert {ɛ}_{il} ) ) ] , \\ 4 ) & ∀ ( j \neq i ) [ ( x ∈ {ɛ}_{ik} ) ⇒ ( P ( x \vert {ɛ}_{ik} ) \geq P ( x \vert {ɛ}_{jl} ) ) ] .\end{matrix}$$

Where P(x|εⱼₗ) is a distribution function of the lth subclass cluster for the data points in category set Sⱼ, i.e., data points of class ωⱼ. In above definition, the Condition 3) describes the intra-class property and the Condition 4) describes the inter-class property of the subclasses. Condition 4) is logically equivalent to
∀(j≠i)[(xεεⱼₗ) [symbol] (P(x|εⱼₗ)>P(x|εᵢₖ))],

Note that the above definition does not exclude a trivial case that each εᵢₖ contains only one data point of Sᵢ. It is known that a classifier built on this case degenerates to a classical one-nearest neighbor classifier. However, considering the efficiency of the classifier to be built, it is more desirable to divide Sᵢ into a least number of subclass clusters. This leads to the introduction of the following definition.

Definition:

Let εᵢₖ and εᵢₗ be two subclass clusters of the data points in Sᵢ, k≠1 & εᵢₗ≠Ø. Let εᵢ=εᵢₖ∪εᵢₗ; and P(X|εᵢ) be the distribution function defined on εᵢ. The subclass cluster set {εᵢₖ; k=1, 2, . . . dᵢ} is a minimum-set subclass clusters of Sᵢ, if for any εᵢ=εᵢₖ∪εᵢₗ we would have:
   ∃(j≠i)∃(xεεⱼₘ)[P(x|εᵢ)>P(x|εⱼₘ)],
   or
   ∃(j·i)∃(xεεᵢ)[P(x|εᵢ)<P(x|εⱼₘ)]

The above definition means that every subclass cluster must be large enough such that any joint set of them would then violate the subclass definition (Condition 4).

According to the Condition 3 of the subclass definition, a subclass region R(ωᵢₖ) corresponding to the subclass εᵢₖ can be defined as
R(ωᵢₖ)={x|∀(l≠k)[P(x|εᵢₖ)>P(x|εᵢₗ)]}.
The P(x|εᵢₖ) thus can be viewed as a distribution function defined on the feature vector xs in R(ωᵢₖ). Combining this with the Condition 2 of the subclass cluster definition, provides:
R(ωᵢₖ)∩R(ωᵢₗ)=Ø, ∀l≠k,
and
R(ωᵢₖ)∩R(ωⱼₗ)=Ø, ∀j≠i.

The subclass clusters thus can be viewed as partitions of the decision region R(ωᵢ) into a number of sub-regions, R(ωᵢₖ), k=1, 2, . . . dᵢ, such that
R(ωik)⊂R(ωᵢ),
and ∪ₖR(ωᵢₖ)=R(ωᵢ).
Observing the fact that R(ωᵢₖ)∩R(ωⱼₗ)=Ø, ∀j≠i, we have
R(ωᵢ)∩R(ωⱼ)=Ø, ∀j≠i.

Traditionally, a multivariate Gaussian distribution function is assumed for most data distributions, that is,

$$p ( x \vert {ω}_{i} ) = \frac{1}{{( 2 π )}^{n / 2} {\vert Σ \vert}^{1 / 2}} {ⅇ}^{[ - \frac{1}{2} {( x - {μ}_{i} )}^{t} {Σ}^{- 1} ( x - {μ}_{i} ) ]} .$$

Thus, giving a set of pattern samples of class ωᵢ, say Sᵢ={x₁, x₂, . . . , xₖ}, in a Gaussian distribution, the determination of the function p(x|ωᵢ) can be viewed approximately as a process of clustering the samples into a hyper-ellipsoidal subspace described by
(x−μ)^{t}Σ⁻¹(x−μ)≦C;
where

$$μ = \frac{1}{k} {\sum }_{i = 1}^{k} {x}_{i} , and$$

$$\sum = \frac{1}{k} {\sum }_{i = 1}^{k} ( {x}_{i} - μ ) {( {x}_{i} - μ )}^{t} .$$

The value C is a constant that determines the scale of the hyper-ellipsoid. Symbol ε is used to denote a hyper-ellipsoid, expressed as,
ε˜(x−μ)^{t}Σ⁻¹(x−μ)≦C.
The parameter C should be chosen such that hyper-ellipsoids properly cover the data points in the set. The idea leads to the Mini-Max hyper-ellipsoidal data characterization of this disclosure where Mini-Max refers to the minimum number of hyper-ellipsoids that span to cover a maximum amount of data points of the same category without intersecting any other hyper-ellipsoids built in the same way (i.e., other Mini-Max hyper-ellipsoids).

The minimization of cross entropy approach, derived from axioms of consistent inference, considers generally a minimum distance measurement for the reconstruction of a real function from finitely many linear function values. Taking the distortion (discrepancy or direct distance) measurement of two functional sets Q(x) and P(x) as
D(Q,P)=∫f(Q(x),P(x))dx.

The cross entropy minimization approach approximates P(x) by a member of Q(x) that minimizes the cross-entropy

$$H ( Q , P ) = \int Q ( x ) log ( \frac{Q ( x )}{P ( x )} ) ⅆ x .$$

Where Q(x) is a collection of admissible distribution functions defined on the various data sets {rₙₖ}, and P(x) a prior estimate function. Expressed as a computation for the clusters of feature vector distributions, a minimization of the cross-entropy H(Q, P) results in taking an expectation of the member components in {rₙₖ}. The best set of data {rₒₖ} to represent the sets {rₙₖ} is given by

$${r}_{ok} = \frac{1}{N} {\sum }_{i = 1}^{N} {r}_{ik} = {\overline{r}}_{k} .$$

Here rᵢₖ corresponds to the data points currently included in a subspace εₖ. r̅ₖ is named a moving centroid of the cluster. That means, when data points are examined one by one and added into the subclass clusters in the construction process, the cluster centroid is adjusted to the new expectation values constantly. Under the moment interpretation of data distributions, the r̅ₖ is the first order moment of masses of the data in the subspace. That is r̅ₖ=μₖ, where μₖ is also called the expectation vector of the data set k. This means that, when samples are examined one by one in the subspace construction process, the cluster centroid is always adjusted to the mean of the components as additional member vectors are added.

Applying the cross-entropy minimization technique to the construction of the probability density functions p(X|ωᵢ) for a given data set, the technique calls for an approximation of the functions under the constrains of the expected values of the data clusters. Correspondently, this obtains:

$${μ}_{ik} = \frac{1}{{N}_{ik}} {\sum }_{{X}_{j} ∈ {ɛ}_{ik}} {x}_{j} ,$$

where Nᵢₖ is the number of data points in the cluster εᵢₖ, i.e., Nᵢₖ=∥εᵢₖ∥. The covariance parameters Σᵢₖ of the clusters can be estimated by extending the results of the moving centroid and expressed as:

$${\sum }_{ik} = \frac{1}{{N}_{ik}} {\sum }_{{x}_{j} ∈ {ɛ}_{ik}} ( {x}_{j} - {μ}_{ik} ) {( {x}_{j} - {μ}_{ik} )}^{t} ,$$

The parameters are to be continuously updated upon the examination of additional data points xs and the addition of them into the selected subclass clusters.

It is useful and convenient to view cross-entropy minimization as one implementation of an abstract information operator “o.” The operator takes two arguments—the a prior function P(x) and new information Iₖ—and yields a posterior function Q(x), that is Q(x)=P(x) o Iₖ, where Iₖ also stands for the known constraints on expected values:
Iₖ: ∫Q(x)gₖ(x)dₓ=rₖ,
where gₖ(x) is a constraint function on x. By requiring the operator o satisfy a set of axioms, the principle of minimum cross-entropy follows.

The axioms of o are informally phrased as the following:
1) Uniqueness: The results of taking new information into account should be unique.
2) Invariance: It should not matter with respect to the coordinate system the data point accounts for new information.
3) System Independence: It should not matter whether information about systems is accounted separately in terms of different probability densities or together in terms of a joint density.
4) Subset Independence: It should not matter whether information about system states is accounted in terms of a separate conditional density or in terms of the full system density.

Thus, given a prior probability density P(x) and new information in the form of constraint Iₖ on expected value rₖ, there is essentially one posterior density function that can be chosen in a manner as the axioms stated above.

Considering two constraints I₁ and I₂ associated with the data modeling expressed as:
I₁: ∫Q₁(x)gₖ(x)dx=rₖ⁽¹⁾,
I₂: ∫Q₂(x)gₖ(x)dx=rₖ⁽²⁾;
where Q₁(x) and Q₂(x) are the density function estimations at two different times. The rₖ⁽¹⁾ and rₖ⁽²⁾ represent the expected values of the function in the consideration of different data points in S, that is, in terms of the new information about Q(x) contained in the data point set {x}. Taking count of these constraints, we have:

$$( P ( x ) o {I}_{1} ) o {I}_{2} = {Q}_{1} ( x ) o {I}_{2}$$

$$and$$

$$H [ {Q}_{2} ( x ) , P ( x ) ] = H [ {Q}_{2} ( x ) , {Q}_{1} ( x ) ] + H [ {Q}_{1} ( x ) , P ( x ) ] + {\sum }_{k = 0}^{M} {β}_{k}^{( 1 )} ( {r}_{k}^{( 1 )} - {r}_{k}^{( 2 )} ) ;$$

where, Q₁(x)=P(x) o I₁, Q₂(x)=P(x) o I₂, and the βₖ⁽¹⁾'s are the Lagrangian multipliers associated with Q₁(x). From these equations we have:

$$H [ Q ( x ) , {Q}_{j} ( x ) ] = H [ Q ( x ) , P ( x ) ] - H [ {Q}_{j} ( x ) , P ( x ) ] - {\sum }_{k = 0}^{M} {β}_{k}^{( 1 )} ( {r}_{k}^{( 1 )} - {r}_{k}^{( 2 )} ) ;$$

Solving H[Qⱼ(x), P(x)] by using equation

$${Q}_{j} ( x ) = P ( x ) exp ( - {λ}^{( j )} - {\sum }_{k = 0}^{M} {β}_{k}^{( j )} {r}_{k}^{( j )} ) ,$$

we have

$$H [ Q ( x ) , {Q}_{j} ( x ) ] = H [ Q ( x ) , P ( x ) ] + {λ}^{( j )} + {\sum }_{k = 0}^{M} {β}_{k}^{( j )} {r}_{k} .$$

where λ^{(j)} and βₖ^{(j)} are the Lagrangian multipliers of Qⱼ(x).
The minimum H[Q(x), Qⱼ(x)] is computed by taking the counts of Iⱼ, j=1, . . . , n (where n is the total number of data points) and a value j such that H[Q(x), Qⱼ(x)]≦H[Q(x), Qᵢ(x)] for i≠j. The process would take count of the data points one at a time, and choose the Qⱼ(x) with respect to the selected the data point that has the minimum distance (nearest neighbor) from the existing functions.

Further exploration of the functions Q(x) reveals a supervised learning process that, viewed as a hypersurface reconstruction problem, is an ill-posed inverse problem. A method called regularization for solving ill-posed problems, according to Tikhonov's regularization theory, states that the features that define the underlying physical process must be a member of a reproducing kernel Hilbert space (RKHS). The simplest RKHS satisfying the needs is the space of a rapidly decreasing, infinitely continuously differentiable function. That is, the classical space S of rapidly decreasing test functions for the Schwartz theory of distributions, with finite P-induced norm, as shown by
Hp={fεS:∥Pf∥<∞}.
Where P is a linear (pseudo) differential operator. The solution to the regularization problem is given by the expansion:

$$F ( x ) = {\sum }_{i = 1}^{N} {w}_{i} G ( x ; {x}_{i} ) ;$$

Where G(x; xᵢ) is the Green's function for the self-adjoining differential operator P*P, and wᵢ is the ith element of the weight vector W.
P*PG(x;xᵢ)=δ(x−xᵢ).
Where δ(x−xᵢ) is a delta function located at x=xᵢ, and
W=(G+λI)⁻¹d.
Where λ is a parameter and d is a specified desired response vector. A translation invariant operator P makes the Green's function G(x; xᵢ) centered at xᵢ depending only on the difference between the arguments x and xᵢ; that is:
G(x;xᵢ)=G(x−xᵢ).

It follows that the solution to the regularization problem is given by a set of symmetric functions (the characteristic matrix must be a symmetric matrix). Using a weighted norm form G(∥x−tᵢ∥cᵢ) for the Green's function, it is suggested the multivariate Gaussian distribution with mean vector μᵢ=tᵢ and covariance matrix Σᵢ defined by (Cᵢ^{T}Cᵢ)⁻¹, as the function to the regularization solution. That is:
G(∥x−tᵢ∥cᵢ)=exp[−(x−tᵢ)^{T}Cᵢ^{T}Cᵢ(x−tᵢ)].
Applying the above result to the subclass construction, we have the functional form for the subspace εᵢₖ P(x|εᵢₖ) expressed as:

$$P ( x \vert {ɛ}_{ik} ) = {Q}_{j} ( x ) = \frac{1}{{( 2 π )}^{n / 2} {\vert {\sum }_{ik} \vert}^{1 / 2}} {ⅇ}^{[ - \frac{1}{2} {( X - {μ}_{ik} )}^{t} {\sum }_{ik}^{- 1} ( X - {μ}_{ik} ) ]} .$$

The parameters μᵢₖ and Σᵢₖ of the distributions can be estimated by utilizing the results of cross-entropy minimization expressed above. It is known that the equal-probability envelopes of the P(x|εᵢₖ) function are hyper-ellipsoids centered at μᵢ with the control axes being the eigen-parameters of the matrix Σᵢ. That is, it can be expressed as:
(x−μᵢ)^{T}Σᵢ⁻¹(x−μi)=C;
where C is a constant.

Geometrically, samples drawn from a Gaussian population tend to fall in a single cluster region. In this cluster, the center of the region is determined by the mean vector μ, and the shape of the region is determined by the covariance matrix Σ. It follows that the locus of points of constant density for a Gaussian distribution forms a hyper-ellipsoid in which the quadratic form (x−μ)^{t}Σ⁻¹(x−μ) equals to a constant. The principal axes of the hyper-ellipsoid are given by the eigenvectors of Σ and the lengths of these axes are determined by the eigenvalues. The quantity
r=\sqrt{(x−μ)^{t}Σ⁻¹(x−μ)}
is called the Mahalanobis distance. That is, the contour of constant density of a Gaussian distribution is a hyper-ellipsoid with a constant Mahalanobis distance to the mean vector μ. The volume of the hyper-ellipsoid measures the scatter of the samples around the point μ.

Moment-Driven Clustering Algorithm:

The algorithm for model construction and data analysis of the present invention is presented as the following.
0) If data points in the data collection are not labeled, label the data according to a pre-determined set of discriminate functions {Pᵢ(x)|i=1, 2, . . . , c}, where x stands for a data point (c=2 if the data points are in two types).
1) Let the whole data collection be a single data block, mark it unpurified, calculate its mean vector μ₀ and co-variance matrix Σ₀, place (μ₀, Σ₀) into the μ−Σ list.
2) While not all data blocks are pure (purity-degree>ε)
   2.1) for each impure block k
      2.1.1) remove (μₖ, Σₖ) from the μ−Σ list.
      2.1.2) compute the (μᵢ, Σᵢ) i=1, 2, . . . , c for each type's data points in the block k.
      2.1.3) insert the (μᵢ, Σᵢ) i=1, 2, . . . , c into the μ−Σ list.
   2.2) for each data point xⱼ in the whole data set place xⱼ into corresponding data block according to the shortest Mahalanobis distance measurement with respect to the (μᵢ, Σᵢ) in the μ−Σ list.
   2.3) for each data block Bₖ, calculate the purity degree according to the purity measurement function Purity-degree (Bₖ).
3) show the data sets before and after the above operation.
4) Post-processing to extract the regularities, irregularities, and other properties of the data sets by examining the sizes of the resulting data blocks.

The algorithm discussion
a) The computational complexity of this algorithm is O(n log n), where n is the number of total data points.
b) Introducing the purity-measurement function: The purity degree of a data block Bₖ of labeled data points is defined as

$$Purity \text{-} degree ( {B}_{k} ) = \frac{min ( \frac{{n}_{1}}{{N}_{1}} , \frac{{n}_{2}}{{N}_{2}} )}{max ( \frac{{n}_{1}}{{N}_{1}} , \frac{{n}_{2}}{{N}_{2}} )} ; assuming c = 2 , \\ Otherwise \frac{{\sum }_{j} \frac{{n}_{j}}{{N}_{j}} ( \begin{matrix}j = 1 , 2 , … , c , and \\ \frac{{n}_{j}}{{N}_{j}} < max ( \frac{{n}_{i}}{{N}_{i}} i = 1 , 2 , … , c )\end{matrix} )}{max ( \frac{{n}_{i}}{{N}_{i}} i = 1 , 2 , … , c )} )$$

Where nᵢ is the number of data points labeled i in data block k; Nᵢ is the total number of data points labeled i in the initial set of overall data points.
Note that we have 0≦Purity-degree(Bₖ) for all Bₖ.

Mini-Max Clustering Algorithm:

The algorithm is divided into two parts, one for the initial characterization process and the other for the accretion process. The initial characterization process can be briefly described in the following three steps.
1) For every data point in the set, form a primary hyper-ellipsoid with parameters corresponding to the values (semiotic components, e.g., key words, nouns, verbs, . . . ) of the data point (i.e., the μ equals to the data point and the Σ an identity matrix);
2) Merge two hyper-ellipsoids to construct a new hyper-ellipsoid that is the minimum size (i.e., an intersection of the Semiotic Centers) while covers all the data points in the original two hyper-ellipsoids, where
   (1) their enclosing data points are in same category,
   (2) the distance (the inverse of similarity) between them are the shortest among all other pairs of the hyper-ellipsoids, and
   (3) the resulting merged hyper-ellipsoid does not intersect with any hyper-ellipsoid of other classes;
3) Repeat the step 2) until no two hyper-ellipsoids can be merged.

The algorithm is also expressed in the following formulation. To simplify the description, the following are specified or restated by the following notations:

c—the total number of classes in data set S.

Sᵢ—a subset of data set S; Sᵢ contains the data points in class ωᵢ, i=1, 2, . . . , c.

x—a data point in an n-dimensional space, xεS.

ε—a subclass cluster; when subscripts are used, εᵢₖ means the kth cluster of Sᵢ.

Eᵢ—the set of subclass clusters for sample set Sᵢ.

∥Eᵢ∥—the number of subclass clusters in set Eᵢ.

Algorithm: Mini-Max Hyper-Ellipsoid Clustering (MMHC)

| | |
|---|---|
| Input: | {Sᵢ}, i = 1, 2, ..., c. |
| Output: | {Eᵢ}, i = 1, 2, ..., c. |

| | |
|---|---|
| Step 1: | for each Sᵢ (i = 1, 2, ..., c) do /* Initialize subclass clusters */ |
| Step 1.1: | Eᵢ [symbol] Ø, \|\|Eᵢ\|\| [symbol] 0; |
| Step 1.2: | for each X ∈ Sᵢ do |
| Step 1.2.1: | ε [symbol] Merge(Ø, X) |
| Step 1.2.2: | Eᵢ [symbol] Eᵢ ∪ {ε}, \|\|Eᵢ\|\|++; |
| Step 2: | Repeat: /* form minimum number, non-intersecting |
| | clusters */ |
| Step 2.1: | find a pair (εᵢₖ, εᵢₗ) |
| | such that (εᵢₖ, εᵢₗ ∈ Eᵢ) & (k ≠ 1) & Distance(εᵢₖ, εᵢₗ) |
| | is the minimum among all pairs of (εᵢₖ, εᵢₗ) in |
| | Eᵢ, i = 1, 2, ..., c; |
| Step 2.2: | ε [symbol] Merge(εᵢₖ, εᵢₗ), |
| Step 2.3: | if NOT(Intersect(ε, εⱼₘ) ∀j ≠ i & ∀m) then |
| Step 2.3.1: | remove εᵢₖ and εᵢₗ from Eᵢ ; Eᵢ [symbol] Eᵢ ∪ {ε}, \|\|Eᵢ\|\| −−; |
| Step 2.3.2: | otherwise disregard ε. |
| Step 2.4: | Until no change is made on every \|\|Eᵢ\|\|. |
| Step 3: | Return {Eᵢ}, i = 1, 2, ..., c. |

Accretion Learning Algorithm:

In the accretion process, a data point is processed through the following steps.
1) Find (Identify) the hyper-ellipsoid that
   (a) has the same label (category) as the data point,
   (b) has the shortest distance to the data point than any other hyper-ellipsoids of the same label (category).
2) Merge the data point with the hyper-ellipsoid (construct a new hyper-ellipsoid that is the minimum size while covers both the new data point and the points in the original hyper-ellipsoid), if the resulting merged hyper-ellipsoid does not intersect with any hyper-ellipsoid of other classes;
3) If the resulting merged hyper-ellipsoid would intersect with hyper-ellipsoids of other category, form a primary hyper-ellipsoid with parameters corresponding to the values of that data point (i.e., the μ equals to the data point and the Σ an identity matrix).

The Algorithm has following properties: (1) After the algorithm terminates, there is no intersection between any two hyper-ellipsoids of different categories (data points are allocated into their correct segments with 100% accuracy); (2) After the algorithm terminates, each hyper-ellipsoid cluster contains a maximum number of data points that are possible to be grouped in it; and (3) After the algorithm terminates, the Mahalanobis distance of a data point to the Modal Center gives an explicit measurement of the uncertainty of a given information piece with respect to the data cluster (information category).

Having described the present invention, it is noted that the method is applicable to both numeric and text information. That is, the semiotic features of text information are mapped to similarity (distance) measurements and then used in clustering. Each block of clusters can be viewed as a statistical segmentation of the numeric-text information space. Further, the hyper-ellipsoids represent Gaussian distributions of the data sets and data subsets. That is, the clusters of numeric-text information are modeled in Gaussian distributions essentially. Though data blocks (clusters) are mathematically modeled in hyper-ellipsoids, the overall shapes of resulting data segments are not necessary in hyper-ellipsoids as the data space are divided (attributed) according to the data block distributions. The data space ends up with a partition that has its separation planes most likely in high order non-linear surfaces.

### EXAMPLE 1

### Clustering Capability

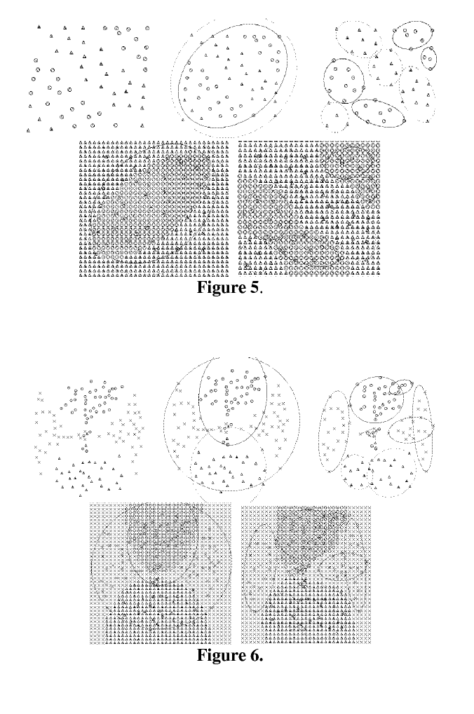

FIGS. 4-6 show that: (1) Data points are grouped into hyper-ellipsoids, (2) These hyper-ellipsoids are split, the size of the hyper-ellipsoids reduces, in a way that data points in each division getting purer gradually, functioning like a vibrating sieve (forming smaller but less mixing bulks of data); (4) Small sized hyper-ellipsoids representing singular or irregular data sets that should be sieved out; and (5) Large sized hyper-ellipsoids containing regularities of the corresponding data type.

FIGS. 4-6 demonstrate that even if the data sets are very much mixed, the clustering moment-drive mini-max clustering algorithm is still capable of dividing them with multiple (>2) sub-divisions.

### EXAMPLE 2

### Classification Capability

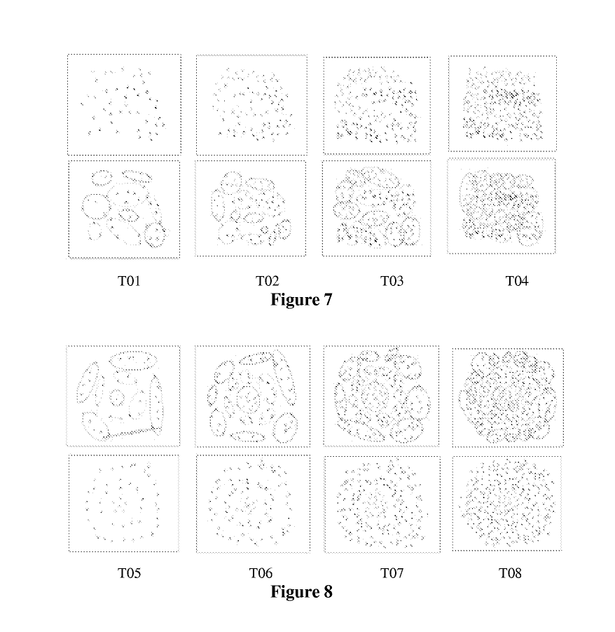

FIGS. 7 and 8 show that data points are grouped into hyper-ellipsoids. In FIG. 7, data points are distributed in a mix of irregular shapes.

In FIG. 8, data points are in three categories distributed in a ring structure. This is generally considered difficult cases to discriminate in traditional data discrimination approaches.

Table 1 shows the test results of the algorithms on the above training sets. It lists the number of data points for each class in the set, the number of hyper-ellipsoid clusters generated by the algorithm, and the classification rate for each class of the data points by the resulting classifier in each case. Note that multiple numbers of Mini-Max hyper-ellipsoids are generated automatically by the algorithm.

TABLE 1
Testing results of the sample sets.

| | # of | # of | |
|---|---|---|---|
| Testing | data points | hyper-ellipsoids | Discrimination |
| set | in each set | generated | rate (%) |
| T01 | 18, 20, 6 | 9 | 100, 100, 100 |
| T02 | 34, 33, 12 | 12 | 100, 97, 100 |
| T03 | 62, 68, 20 | 12 | 100, 100, 100 |
| T04 | 99, 114, 35 | 18 | 98, 100, 100 |
| T05 | 6, 14, 29 | 10 | 100, 100, 100 |
| T06 | 13, 30, 48 | 14 | 100, 100, 100 |
| T07 | 25, 62, 88 | 17 | 100, 100, 100 |
| T08 | 43, 92, 157 | 29 | 97, 100, 99 |

The lower discrimination rates of the testing examples T04 and T08 are due to the exact overlap of the data points of different categories in the data set.

### EXAMPLE 3

### Application to perform Pattern Recognition

The Mini-Max hyper-ellipsoidal model technique was tested on a real world pattern classification example. The example used the Iris Plants Data Set that has been used in testing many classic pattern classification algorithms. The data set consists of 3 classes (Iris Setosa, Versicolour, and Virginica), each with 4 numeric attributes (i.e., four dimensions), and a total of 150 instances (data points), 50 in each of the three classes. Table 2 shows a portion of the data sets.

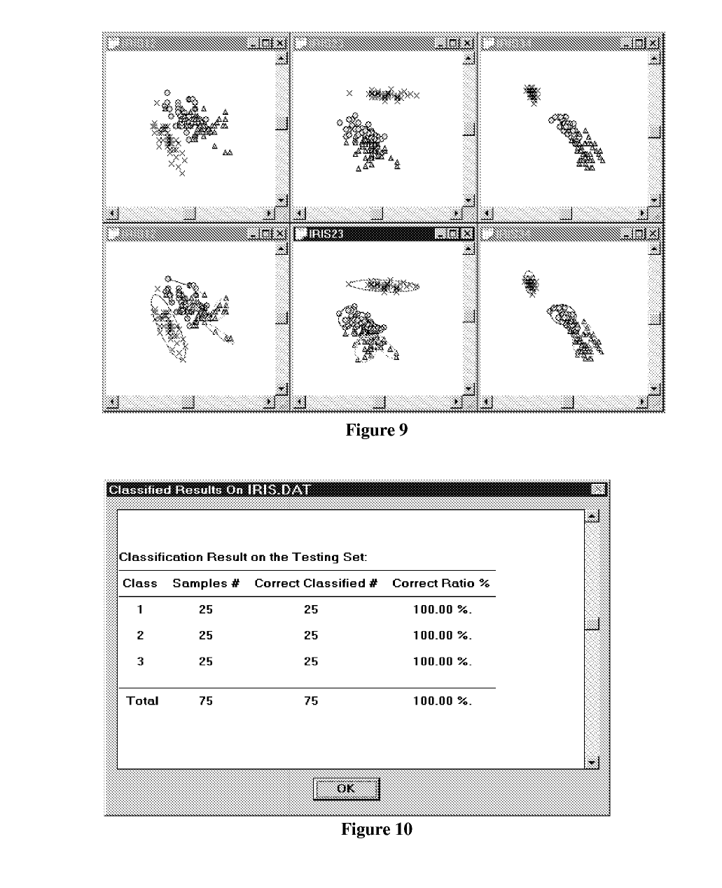

Among the samples in the Iris data set, one data class is linearly separable from the other two, but the other two are not linearly separable from each other. FIG. 9 shows the sample distributions and their subclass regions in three selected 2D projections with respect to the data attributes (dimensions), 1-2, 2-3, and 3-4. FIG. 10 shows the classification results on the test data set.

TABLE 2

| | | | | |
|---|---|---|---|---|
| 5.1 | 3.5 | 1.4 | 0.2 | Iris-setosa |
| 4.9 | 3.0 | 1.4 | 0.2 | Iris-setosa |
| 4.7 | 3.2 | 1.3 | 0.2 | Iris-setosa |
| 4.6 | 3.1 | 1.5 | 0.2 | Iris-setosa |
| 5.0 | 3.6 | 1.4 | 0.2 | Iris-setosa |
| 5.4 | 3.9 | 1.7 | 0.4 | Iris-setosa |
| 4.6 | 3.4 | 1.4 | 0.3 | Iris-setosa |
| 5.0 | 3.4 | 1.5 | 0.2 | Iris-setosa |
| 4.4 | 2.9 | 1.4 | 0.2 | Iris-setosa |
| 4.9 | 3.1 | 1.5 | 0.1 | Iris-setosa |
| 5.4 | 3.7 | 1.5 | 0.2 | Iris-setosa |
| 4.8 | 3.4 | 1.6 | 0.2 | Iris-setosa |
| 7.0 | 3.2 | 4.7 | 1.4 | Iris-versicolor |
| 6.4 | 3.2 | 4.5 | 1.5 | Iris-versicolor |
| 6.9 | 3.1 | 4.9 | 1.5 | Iris-versicolor |
| 5.5 | 2.3 | 4.0 | 1.3 | Iris-versicolor |
| 6.5 | 2.8 | 4.6 | 1.5 | Iris-versicolor |
| 5.7 | 2.8 | 4.5 | 1.3 | Iris-versicolor |
| 6.3 | 3.3 | 4.7 | 1.6 | Iris-versicolor |
| 4.9 | 2.4 | 3.3 | 1.0 | Iris-versicolor |
| 6.6 | 2.9 | 4.6 | 1.3 | Iris-versicolor |
| 5.2 | 2.7 | 3.9 | 1.4 | Iris-versicolor |
| 5.0 | 2.0 | 3.5 | 1.0 | Iris-versicolor |
| 5.9 | 3.0 | 4.2 | 1.5 | Iris-versicolor |
| 6.3 | 3.3 | 6.0 | 2.5 | Iris-virginica |
| 5.8 | 2.7 | 5.1 | 1.9 | Iris-virginica |
| 7.1 | 3.0 | 5.9 | 2.1 | Iris-virginica |
| 6.3 | 2.9 | 5.6 | 1.8 | Iris-virginica |
| 6.5 | 3.0 | 5.8 | 2.2 | Iris-virginica |
| 7.6 | 3.0 | 6.6 | 2.1 | Iris-virginica |
| 4.9 | 2.5 | 4.5 | 1.7 | Iris-virginica |
| 7.3 | 2.9 | 6.3 | 1.8 | Iris-virginica |
| 6.7 | 2.5 | 5.8 | 1.8 | Iris-virginica |
| 7.2 | 3.6 | 6.1 | 2.5 | Iris-virginica |
| 6.5 | 3.2 | 5.1 | 2.0 | Iris-virginica |
| 6.4 | 2.7 | 5.3 | 1.9 | Iris-virginica |

### EXAMPLE 4

### Application to Anomaly Detection and Decision Support

In decision make, when a decision point is located at a very purified region of the data space, it means the decision is more reliable (with high certainty), while a decision point falling in a highly impure region means the decision is more doubtable and less reliable. Generally, decisions are made based on the satisfactory of both the necessary and sufficient conditions of the issue. It is desirable to have a decision made on the bases of satisfaction of both the necessary and sufficient conditions. A decision may be made with sufficient conditions under the limitations and constrains of the uncertainties of the information systems and inference mechanisms.

The credit card record data (2 class patterns) show that by purifying data into multiple clusters, some clusters become uniquely contained (same class sample distributions emerge). These clusters provide a sufficient condition for reliable decision-making.

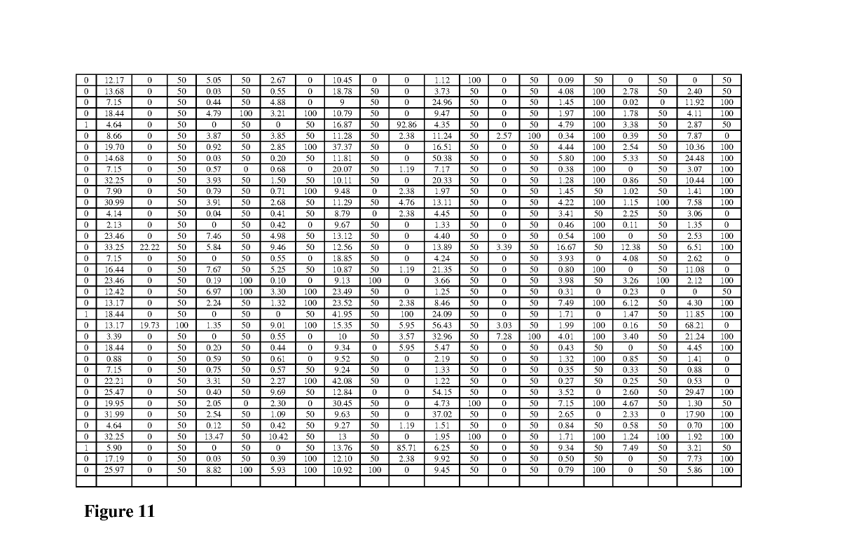

The data set listed in Table 3 shown in FIG. 11 is a collection of records that keeps track of personal financial transactions including monthly balance, spending, payment, rate of change of these data month-by-month, etc. A total of 20 columns of these data were acquired. Each row is one record. The first column uses digital 0 and 1 to indicate whether the financial record is in good standing or not. The first 40 rows of the data records are shown in the table of FIG. 11.

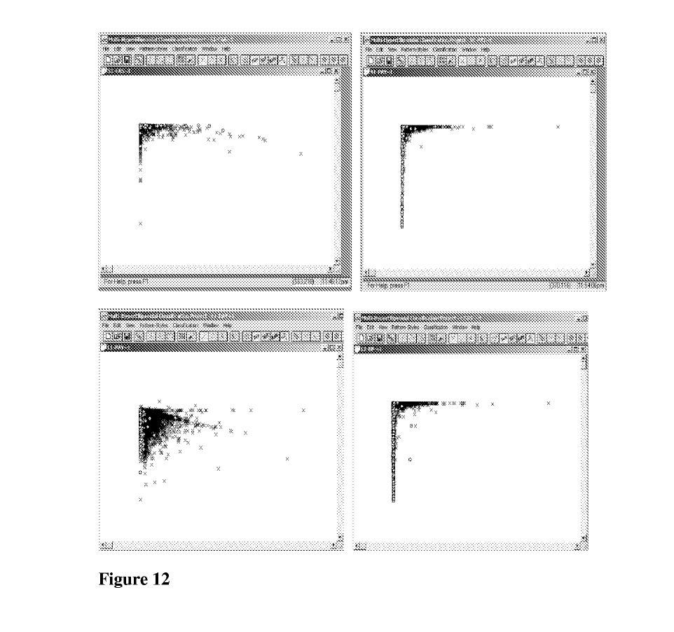

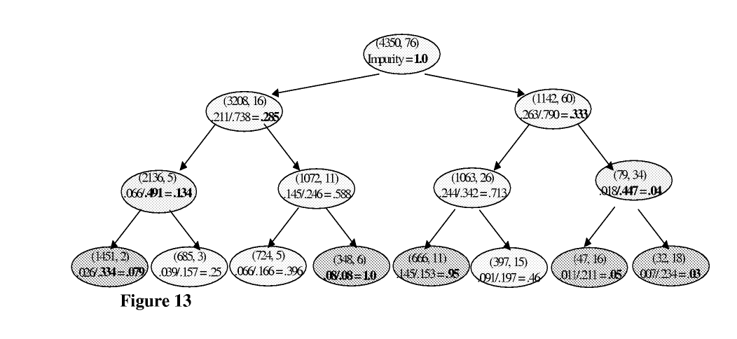

FIG. 12 are the illustrations of data distributions (from different dimensional views). It is seen that these data sets are very highly mixed (intertwining) and therefore very difficult to analysis in general. FIG. 13 is a binary tree showing the purification of the data sets by applying the hyper-ellipsoidal clustering and subdivisions.

Results Analysis:

1. Total purified data (Impurity value<0.1)
For type 1 data (1451 out of 4350 points)=0.334=33.4%
For type 2 (16_{—}18 out of 76 points)=0.211+0.234=44.5%

2. Singular data points (Impurity value>0.5) detected
For type 1 data (348 out of 4350 points)=0.08=8.0%
For type 2 (11 out of 76 points)=0.145=14.5%

The same process may be applied for Web data traffic analysis and for network intrusion detection, thus supporting Internet security and information assurance.

The usage of the data system and method of the present invention provides for the cleansing or purifying of data collections to find irregularity (singularity) points in the data sets, and then rid the data collections of these irregularity points. Further the method and system of the present invention provides for the segmentation (clustering) of data collections into a number of meaningful subsets. This is applicable to image/video frame segmentation as well where the shapes (size, orientation, and location) of the data segments may be used to describe (approximately) and identify the images or video frames.

In data mining, association rules about certain data records (such as business transactions that reveal the association of sales of one product item to the other one) may be discovered from those large data blocks identified by the process and method of the present invention.

The process and method of the present invention may serve as a contents-based description/identification of given data sets. Further, it may detect and classify data sets according to intra similarity and inter dissimilarity; make data comparison, discovering associative components of the data sets; and support decision-making by isolating (separating) best decision regions from uncertainty decision regions.

The present invention has been described in relation to a particular embodiment, which is intended in all respects to be illustrative rather than restrictive. Alternative embodiments will become apparent to those skilled in the art to which the present invention pertains without departing from its scope.

The invention claimed is:

1. In a computer data processing system, a method for clustering data in a database comprising:
a. providing a database having a number of data records having both discrete and continuous attributes;
b. configuring the set of data records into one or more hyper-ellipsoidal clusters having a minimum number of the hyper-ellipsoids covering a maximum amount of data points of a same category; and
c. recursively partitioning the data sets to thereby infer the discriminative nature of the data sets.

2. The method of claim 1 wherein the step of configuring the data records into one or more hyper-ellipsoidal clusters comprises the steps of:
Characterizing the data; and
Accreting the data.

3. The method of claim 2 wherein the step of characterizing the data records comprises the steps of:
Forming a primary hyper-ellipsoid having parameters corresponding to values of the data point.

4. The method of claim 3 wherein the step of accreting the data comprises the steps of:
(1) calculating the distance between hyper-ellipsoids having the same category;
(2) determining the shortest distance between the pairs of hyper-ellipsoids having the same category; and
(3) merging the two hyper-ellipsoid having the shortest distance and sharing the same category if the resulting merged hyper-ellipsoid does not intersect with any other hyper-ellipsoid of an other class.

5. The method of claim 4 wherein the step of merging the two hyper-ellipsoids further includes the step of repeating steps (1) through (3) until no hyper-ellipsoids may be further merged.

6. The method of claim 5 further including the step of:
Measuring the degree of uncertainty of the information with respect to a category of information.

7. The method of claim 6 wherein the step of measuring the degree of uncertainty comprises the steps of:
Determining the Mahalanobis distance of a data point to the Modal Center.

8. The method of claim 1 further including the steps of:
cleansing the data records.

9. The method of claim 8 wherein the step of cleansing the data records comprises the steps of:
Finding singularity points in the data records; and
Removing the singularity points from the data records.

10. The method of claim 1 wherein the method is applied to image frame segmentation.

11. The method of claim 10 further comprising the steps of:
Describing the size, orientation, and location of a data segment of a data record; and
Identifying the image frame.

12. The method of claim 1 wherein the method is applied to video frame segmentation.

13. The method of claim 12 further comprising the steps of:
Describing the size, orientation, and location of a data segment of a data record; and
Identifying the video frame.

14. The method of claim 1 further comprising the step of providing a contents-based description of the data records in the database.

15. The method of claim 1 further comprising the step of classifying the data records according to intra similarity and inter dissimilarity.

16. The method of claim 1 further comprising the step Supporting decision-making by isolating best decision regions from uncertainty decision regions.
